(19) United States
(12) Patent Application Publication
(10) Pub. No.: US 2017/0113757 A1
(43) Pub. Date: Apr. 27, 2017

(54) Auxiliary Drive and Method for Providing Torque Assistance

(71) Applicant: Bayerische Motoren Werke Aktiengesellschaft, Muenchen (DE)

(72) Inventor: Stefan KAINDL, Friedberg (DE)

(21) Appl. No.: 15/398,896

(22) Filed: Jan. 5, 2017

Related U.S. Application Data
(63) Continuation of application No. PCT/EP2015/066542, filed on Jul. 20, 2015.

(30) Foreign Application Priority Data
Sep. 5, 2014 (DE) 10 2014 217 758.8

(51) Int. Cl. B62M 6/50; B60L 15/20

(52) U.S. Cl. CPC B62M 6/50; B60L 15/20; B60L 2200/12; B60L 2240/423; B60L 2240/642

(57) ABSTRACT

An auxiliary drive that assists the manual maneuvering of a motor vehicle. The auxiliary drive includes an electric motor moving the motor vehicle, and at least one sensor, which detects a pulling and/or pushing of the electric motor vehicle by a user. As a function of an activation state detected by the sensor, the electric motor vehicle generates a torque driving the motor vehicle, in order to assist the pulling or pushing of the electric motor vehicle.

### CROSS REFERENCE TO RELATED APPLICATIONS

This application is a continuation of PCT International Application No. PCT/EP2015/066542, filed Jul. 20, 2015, which claims priority under 35 U.S.C. §119 from German Patent Application No. 10 2014 217 758.8, filed Sep. 5, 2014, the entire disclosures of which are herein expressly incorporated by reference.

### BACKGROUND AND SUMMARY OF THE INVENTION

The embodiments of the invention relate to an auxiliary drive of an electric motor vehicle and to a method for providing torque assistance.

It is difficult to manually move motor vehicles, particularly two-wheelers, in uneven terrain or over obstacles, such as a curbside. In addition, the balance of the two-wheeler has to be maintained during the manual maneuvering, making the manual maneuvering of a two-wheeler even more difficult. The difficulty generally increases with the weight of the motor vehicle to be maneuvered, so that the manual maneuvering of electric two-wheelers is particularly difficult. In the case of electric vehicles, balance has to be maintained, on the one hand, and on the other hand, electric two-wheelers have a higher weight because of the batteries.

Auxiliary drives generally assist a manual maneuvering of a two-wheeler. These auxiliary drives each have an activating element, such as a switch or a control lever, which has to be pressed or activated by the user of the two-wheeler, so that the auxiliary drive provides torque assistance.

Operation of these auxiliary drives is difficult because of the simultaneous coordination of the activation and the manual maneuvering. Particularly in the case of activating elements, which are capable of providing the different assistance speeds, such as a control lever, the coordination is difficult because the balance of the two-wheeler and the activation element simultaneously have to be held in a defined position.

An object of the embodiments of the invention provides an auxiliary drive which assists the manual maneuvering of the motor vehicle by simple means and in a user-friendly manner.

According to the embodiments of the invention, this and other objects are achieved by an auxiliary drive of an electric motor vehicle, particularly an auxiliary drive of an electric two-wheeler, which assists the manual maneuvering of the motor vehicle, having an electric motor moving the motor vehicle and at least one sensor, which detects a pulling and/or pushing of the electric motor vehicle by a user, wherein, as a function of an activation state detected by the sensor, the electric motor generates a torque driving the motor vehicle in order to assist the pulling or pushing of the electric motor vehicle.

In the auxiliary drive disclosed herein the auxiliary drive will automatically recognize when an assisting torque, which drives the motor vehicle, is to be made available. The pulling and/or pushing of the motor vehicle by the user is automatically detected, so that the user does not have to manually operate a specifically designed activating element. The operation of the auxiliary drive is thereby considerably facilitated, and the natural pulling and/or pushing motion is assisted.

Furthermore, the sensor can differentiate between a pushing and a pulling.

In the auxiliary drive disclosed herein the sensor is present in the region of defined application points at which the user grips the motor vehicle for the manual maneuvering. Depending on the design of the motor vehicle, the latter has specific application points at which the user typically touches the motor vehicle, in order to maneuver it manually. Because the sensor is arranged in the region of these application points, it can directly detect the pulling or pushing of the electric motor vehicle by the user.

In particular, the sensor is arranged on a handlebar of the electric motor vehicle at the transition from the handlebar to a steering column. Specifically in the case of a two-wheeler, the user of the motor vehicle typically grips the handlebar in order to manually maneuver the motor vehicle. This is correspondingly immediately detected by the sensor arranged there.

Additionally, the sensor may be a force sensor, which detects a force. The sensor thereby detects the force applied by the user to the electric motor vehicle, in order to detect a pulling and/or pushing by the user. The force applied by the user to the electric motor vehicle is the activation state that is detected by the sensor.

In particular, the speed of the electric motor vehicle caused by the assisting torque is proportional, particularly linearly, to the detected force. The sensor thereby detects the mount of the applied force. As a function of the detected force, the auxiliary drive provides an assisting torque such that the resulting speed is proportional, particularly linearly proportional, to the force. A pushing assistance that is analogous to the force is thereby generated. This facilitates the manual maneuvering because, for example, a greater slope can be deduced from a higher force. The then higher assisting torque will have the result that a manual maneuvering on a steep slope may require the same expenditure of force as in the plane.

Further, the sensor may detect a pulling and/or pushing in a direction that is essentially parallel to the running direction of at least one wheel, particularly of the front wheel. The sensor thereby detects only that force component that is applied to the defined points of application, which is parallel to the running direction of the wheel. A pressing onto the handlebar of a two-wheeler from above is thereby only fractionally detected by the sensor as pushing or pulling because the main component of the force is perpendicular to the running direction of the front wheel. The torque provided by the auxiliary drive thereby assists only an actual pushing or pulling along the intended path.

In particular, the electric motor is activated as a maneuvering assistant by a control only if the detected force for the pulling/pushing is greater than 25 N, particularly greater than 50 N.

Furthermore, an occupancy sensor may be provided which detects the occupancy of a vehicle seat, particularly of the driver's seat, wherein the electric motor will generate the assisting torque only if the occupancy sensor determines a non-occupancy of the seat. As a result, a safety function is created, so that the assisting torque will be provided only if the force applied to the handlebar by the driver is in fact a pulling or pushing for the manual maneuvering. It is, for example, imaginable that the driver might press in the travel direction against the handlebar of the two-wheeler during the drive. As a result of the safety function, it will then be ensured that no assisting torque will be provided in this case.

In particular, the electric motor is the driving motor of the motor vehicle. As a result, a particularly simple and light construction of the electric motor vehicle is created, because no additional motor has to be installed for the auxiliary drive.

Furthermore, the embodiments of the invention relate to a method for providing an assisting torque by means of an auxiliary drive of the above-mentioned type, in which the at least one sensor detects an activation state, a control triggers the electric motor as a function of the detected activation state, and the electric motor provides an assisting drive torque.

The auxiliary drive automatically provides a supporting drive torque by way of the electric motor, when this is required. The sensor detects an activation state, which is identified as such by the control. The user therefore does not have to operate an activation element in order to obtain an assisting torque.

Additionally, the sensor may detect a force, whose effective direction is essentially parallel to the running direction of a wheel of the electric vehicle, especially of the front wheel. Correspondingly, as explained above, the assisting torque is provided only if a force is applied which allows a conclusion concerning a pulling or pushing of the motor vehicle on the basis of a manual maneuvering.

Furthermore, the electric motor can generate an assisting torque that is proportional to the detected force, so that the speed of the electric motor vehicle caused by the assisting torque is proportional, especially linearly proportional, to the detected force. The provided assisting torque is therefore force-proportional with respect to the force applied by the user.

Moreover, an occupancy sensor may be used which detects the presence of a driver of the electric motor vehicle, in which case, the control will then trigger the electric motor only if the occupancy sensor is sending a non-occupancy signal.

Additional advantages and characteristics of the embodiments of the invention are indicated in the following description and in the drawings, to which reference is made.

Other objects, advantages and novel features of the embodiments of the present invention will become apparent from the following detailed description of one or more preferred embodiments when considered in conjunction with the accompanying drawings, in which:

### BRIEF DESCRIPTION OF THE DRAWINGS

FIG. 1 is a frontal view of the motor vehicle;

FIG. 2 is a schematic representation of the auxiliary drive;

FIG. 3 is a top view of a handlebar of a motor vehicle according to FIG. 1;

FIG. 4 is a schematic representation of a pushed motor vehicle on a slope; and

FIG. 5 is a diagram which illustrates the assisting speed caused by the auxiliary drive as a function of the pressure applied by the user.

### DETAILED DESCRIPTION OF THE DRAWINGS

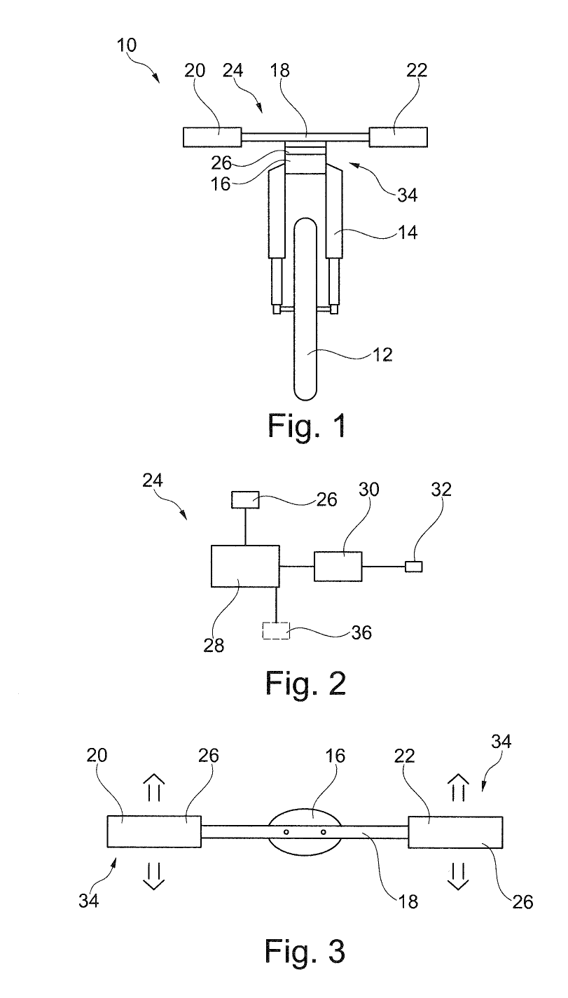

FIG. 1 is a frontal view of a motor vehicle 10 in the form of a two-wheeler.

The motor vehicle 10 has a front wheel 12, which is coupled by way of a fork 14 and a steering column 16 with a handlebar 18 having a first grip 20 as well as a second grip 22 at its axial ends.

The motor vehicle 10 further comprises an auxiliary drive 24, which is schematically illustrated in FIG. 2.

The auxiliary drive 24 has a sensor 26, which recognizes a pulling and/or pushing of the motor vehicle 10. The sensor 26 may be designed as a force sensor, which detects a force applied by the user of the motor vehicle 10 to the motor vehicle 10 and transmits it to a control 28, which analyzes the data detected by the sensor 26. The control 28 can then detect the data acquired by the sensor as an activation state for the auxiliary drive 24.

The activation state detected by the sensor 26 is processed in the control 28, the control 28 determining not only an activation state but also the amount of the force applied by the user. It is further analyzed whether there is a pushing or pulling, i.e. the direction of the force effect.

As a function of the applied and determined force, the control 28 correspondingly triggers an electric motor 30, so that the electric motor 30 drives a driving wheel 32 by means of a torque such that the speed of the vehicle 20 generated by the driving wheel 32 is linearly proportional to the detected force. The auxiliary drive 24 is therefore a force-analogous auxiliary drive.

So that the auxiliary drive 24 detects the pulling and/or pushing of the motor vehicle 10, the sensor 26 is arranged in a region of defined points 34 of application (see FIG. 1). The points of application 34 are defined as locations at which the user typically grips the motor vehicle in order to displace it manually.

As shown in FIG. 1, the sensor 26 is arranged, for example, at the transition from the handlebar 18 to the steering column 16. The user of the motor vehicle typically grips within the region of the handlebar 18 or of the steering column 16, in order to manually pull or push the motor vehicle. This region therefore also represents the region of defined points 34 of application because the force for the pulling/pushing is transferred to the chassis in this region.

FIG. 3 is a top view of a handlebar 18 of the motor vehicle 10. In this embodiment, two sensors 26 are arranged in the handlebar 18 itself, particularly in the grips 20, 22, which therefore form the defined points 34 of application.

The at least one sensor 26 is generally arranged in or at the motor vehicle 10 such that it detects only a pulling and/or pushing in one direction, which essentially is parallel to the running direction of the driving wheel or of the front wheel 12. It is thereby ensured that the pulling and/or pushing detected by the at least one sensor 26 is in fact a result of a manual maneuvering of the motor vehicle 10.

The driving wheel may particularly be the front wheel 12.

Alternatively, the auxiliary drive 24 may, in addition, have an optional occupancy sensor 36, which is indicated by a broken line in FIG. 2.

The occupancy sensor 36 recognizes the occupancy of a vehicle seat, particularly of the driver's seat, and is also coupled with the control 28. The control 28 will control the electric motor 30 only when a force applied to the motor vehicle 10 is detected by the sensor 26 and simultaneously the occupancy sensor 36 recognizes the non-occupancy of the correspondingly assigned seat. This ensures that the auxiliary drive 24 will provide no additional torque when the driver is sitting in the seat and does not push against the handlebar 18 when traveling or at a traffic light.

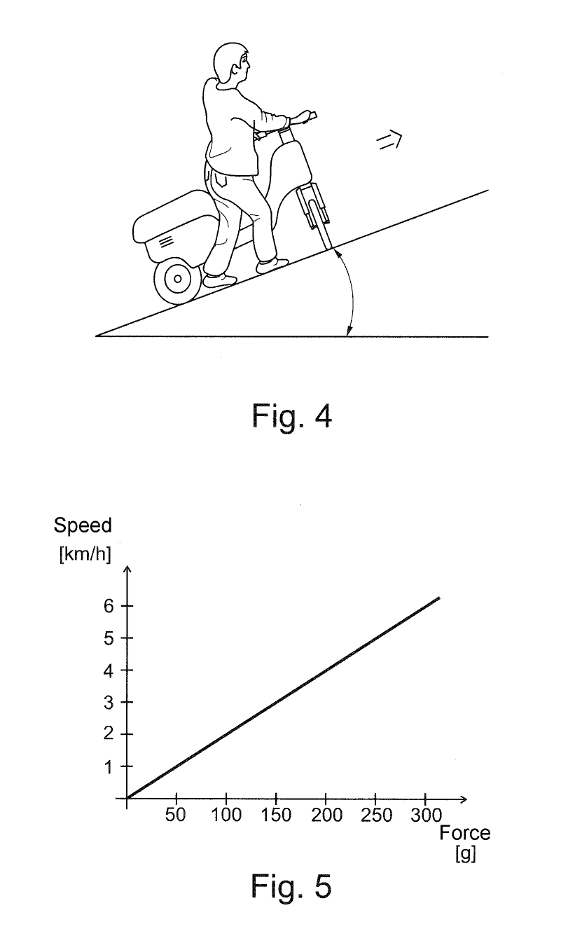

FIGS. 4 and 5 further illustrate that the auxiliary drive 24 has a force-analogous construction because it provides a torque that is proportional to the force detected by the sensor 26.

For example, as a function of the slope, along which the user of the motor vehicle 10 is pushing the latter (FIG. 4), a speed is thereby provided by way of the auxiliary drive 24, which is linearly proportional to the applied force or pressure (FIG. 5).

This correspondingly facilitates the pushing also in the case of very steep slopes by way of the auxiliary drive, so that, for example, as a result of the provided assisting torque, it feels to the user of the motor vehicle like a manual maneuvering in a plane.

The electric motor 30, which provides the assisting torque, is particularly the driving motor of the electric motor vehicle 10. The weight of the motor vehicle 10 can be minimized despite the additionally provided auxiliary drive 24. The control 28 of the auxiliary drive 24 can be constructed as part of the existing control of the motor vehicle 10. Only the sensors 26 as well as the wiring of the sensors 26 to the control 28 carry weight as additional components.

Through the auxiliary drive 24, it therefore becomes possible to manually maneuver a motor vehicle 10 in a simple and user-friendly manner, because the natural pushing and pulling movement is assisted by the auxiliary drive 24. For the assistance, a manual activating by way of an activating element will not be necessary, whereby the operating comfort is correspondingly increased.

The foregoing disclosure has been set forth merely to illustrate the embodiments of the invention and is not intended to be limiting. Since modifications of the disclosed embodiments incorporating the spirit and substance of the embodiments of the invention may occur to persons skilled in the art, the embodiments of the invention should be construed to include everything within the scope of the appended claims and equivalents thereof.

What is claimed is:

1. An auxiliary drive of an electric motor vehicle, particularly an auxiliary drive of an electric two-wheeler, which assists the manual maneuvering of the motor vehicle, comprising:
an electric motor moving the motor vehicle; and
at least one sensor, which detects a pulling and/or pushing of the electric motor vehicle by a user, wherein
as a function of an activation state detected by the sensor, the electric motor vehicle generates a torque driving the motor vehicle, in order to assist the pulling or pushing of the electric motor vehicle.

2. The auxiliary drive according to claim 1, wherein the sensor is present in the region of defined application points at which the user grips the motor vehicle for the manual maneuvering.

3. The auxiliary drive according to claim 2, wherein the sensor is arranged on a handlebar of the electric motor vehicle or at the transition from the handlebar to a steering column.

4. The auxiliary drive according to claim 3, wherein the sensor is a force sensor which detects a force.

5. The auxiliary drive according to claim 4, wherein the speed of the electric motor vehicle caused by the assisting torque is proportional, particularly linearly proportional to the detected force.

6. The auxiliary drive according to claim 5, wherein the sensor detects a pulling and/or pushing in a direction that is essentially parallel to the running direction of at least one wheel, particularly of the front wheel.

7. The auxiliary drive according to claim 6, wherein an occupancy sensor is provided, which detects the occupancy of a vehicle seat, particularly of the driver's seat, and the electric motor generates the assisting torque only when the occupancy sensor determines a non-occupancy of the seat.

8. The auxiliary drive according to claim 7, wherein the electric motor is the driving motor of the motor vehicle.

9. A method for providing an assisting torque via an auxiliary drive of an electric motor vehicle, particularly an auxiliary drive of an electric two-wheeler, which assists the manual maneuvering of the motor vehicle, the method comprising the acts of:
moving the motor vehicle using an electric motor; and
detecting a pulling and/or pushing of the electric motor vehicle by a user, using at least one sensor, wherein
as a function of an activation state detected by the sensor, the electric motor vehicle generates a torque driving the motor vehicle, in order to assist the pulling or pushing of the electric motor vehicle,
the at least one sensor detects an activation state,
a control triggers the electric motor as a function of the detected activation state, and
the electric motor provides an assisting drive torque.

10. The method according to claim 9, wherein the sensor detects a force whose effective direction is essentially parallel to the running direction of a wheel of the electric motor vehicle, particularly of the front wheel.

11. The method according to claim 10, wherein the electric motor generates an assisting torque proportional to the detected force, so that the speed of the electric motor vehicle caused by the assisting torque is proportional, particularly linearly proportional to the detected force.

12. The method according to claim 9, wherein an occupancy sensor is provided, which detects the presence of a driver of the electric motor vehicle, the control triggering the electric motor only when the occupancy sensor sends a non-occupancy signal.

13. The method according to claim 10, wherein an occupancy sensor is provided, which detects the presence of a driver of the electric motor vehicle, the control triggering the electric motor only when the occupancy sensor sends a non-occupancy signal.

14. The method according to claim 11, wherein an occupancy sensor is provided, which detects the presence of a driver of the electric motor vehicle, the control triggering the electric motor only when the occupancy sensor sends a non-occupancy signal.
